(19) United States
(12) Patent Application Publication
(10) Pub. No.: US 2024/0258536 A1
(43) Pub. Date: Aug. 1, 2024

(54) FUEL CELL SYSTEM

(71) Applicants: TOYOTA JIDOSHA KABUSHIKI KAISHA, Toyota-shi (JP); DENSO CORPORATION, Kariya-city (JP)

(72) Inventors: Tsuyoshi MARUO, Okazaki-shi (JP); Tamaki ISHIKAWA, Kariya-shi (JP)

(73) Assignees: TOYOTA JIDOSHA KABUSHIKI KAISHA, Toyota-shi (JP); DENSO CORPORATION, Kariya-city (JP)

(21) Appl. No.: 18/531,650

(22) Filed: Dec. 6, 2023

(30) Foreign Application Priority Data
Jan. 27, 2023 (JP) 2023-010708

(51) Int. Cl. H01M 8/04119; H01M 8/04492; H01M 8/04746; H01M 8/04828

(52) U.S. Cl. CPC H01M 8/04179; H01M 8/04522; H01M 8/04753; H01M 8/04843

(57) ABSTRACT

A fuel cell system includes: a fuel cell; a water content estimation unit; and an anode scavenging setting unit. The water content estimation unit estimates a water content of a cathode of the fuel cell before scavenging of the cathode is started, and the anode scavenging setting unit sets time and start timing of scavenging of an anode of the fuel cell based on the water content.

### CROSS-REFERENCE TO RELATED APPLICATION

This application claims priority to Japanese Patent Application No. 2023-010708 filed on Jan. 27, 2023, incorporated herein by reference in its entirety.

### BACKGROUND

### 1. Technical Field

The present disclosure relates to a fuel cell system.

### 2. Description of Related Art

Various techniques have been proposed for fuel cells (FCs). Japanese Unexamined Patent Application Publication No. 2015-109137 (JP 2015-109137 A) discloses a technique in which, when a fuel cell is in a high moisture state, a boost rate is increased to facilitate discharge of liquid water from an anode passage.

### SUMMARY

In the related art, depending on the completion time of scavenging in a cathode, product water may be stored again, or a large amount of fuel gas may be consumed, leading to poor scavenging efficiency, which is problematic.

The present disclosure has been made in view of the above circumstances, and it is a main object of the present disclosure to provide a fuel cell system capable of efficient scavenging.

In the present disclosure, there is provided a fuel cell system including:
a fuel cell; a water content estimation unit; and an anode scavenging setting unit.

The water content estimation unit estimates a water content of a cathode of the fuel cell before scavenging of the cathode is started, and
the anode scavenging setting unit sets time and start timing of scavenging of an anode of the fuel cell based on the water content.

In the present disclosure, the water content estimation unit estimates the water content of the cathode during the scavenging of the cathode and calculates a water content change rate, and
the anode scavenging setting unit changes the time and start timing of the anode scavenging based on the water content change rate.

The fuel cell system of the present disclosure can efficiently perform scavenging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating an example of a fuel cell system of the present disclosure;

FIG. 2 is a graph illustrating an example of a relationship between the scavenging time and the impedance of a cathode of a fuel cell;

FIG. 3 is a graph illustrating another example of the relationship between the scavenging time and the impedance of the cathode of the fuel cell;

FIG. 4 is a flowchart illustrating an example of control performed by the fuel cell system of the present disclosure;

FIG. 5 is a flowchart illustrating another example of the control performed by the fuel cell system of the present disclosure; and

FIG. 6 is a flowchart illustrating another example of the control performed by the fuel cell system of the present disclosure.

### DETAILED DESCRIPTION OF EMBODIMENTS

Embodiments according to the present disclosure will be described below. Note that matters other than those specifically referred to herein and necessary for the practice of the present disclosure (e.g., a general configuration and manufacturing process of a fuel cell system that does not characterize the present disclosure) may be understood as design matters of those skilled in the art based on the related art in the field. The present disclosure may be implemented based on what is disclosed herein and general technical knowledge.

In the present specification, the term “to”, which indicates a numerical range, is used to signify that the range includes numerical values listed before and after “to” as lower and upper limits.

Any combination of the upper and lower limits in the numerical range can be adopted.

In the present disclosure, there is provided a fuel cell system including:
a fuel cell; a water content estimation unit; and an anode scavenging setting unit.

The water content estimation unit estimates a water content of a cathode of the fuel cell before scavenging of the cathode is started, and
the anode scavenging setting unit sets time and start timing of scavenging of an anode of the fuel cell based on the water content.

The related art for a drainage method within a fuel cell in a fuel cell system includes a technique that involves increasing the opening degree of a linear solenoid valve (LSV) at any speed to enhance the drainage performance of a manifold, operating an exhaust drain valve according to the inclination, and changing exhaust treatment intervals.

When the LSV valve opening speed is determined based solely on the drainage time of an anode (An), and the scavenging of a cathode (Ca) is then performed after the anode drainage, power generation product water permeates the anode, resulting in insufficient scavenging and a deterioration in fuel consumption. When the cathode drainage has not been completed, product water accumulates in the anode due to the cathode drainage process. When the anode drainage is completed before the completion of the cathode drainage, the drainage ends earlier than necessary, resulting in large fuel consumption and a deterioration in fuel consumption.

Hence, there is a concern that, according to the related art, the control cannot be performed with optimal fuel efficiency. Therefore, in the present disclosure, the time and start timing of the anode scavenging (drainage) are controlled based on the drainage status (impedance value) of the cathode. The impedance value varies with the humidity in the fuel cell or the gas, even at the same flow rate, and thus, correction is made based on the humidified state as well.

In the present disclosure, the scavenging can be efficiently performed by setting the time and start timing of the anode scavenging according to the cathode scavenging time.

In the present disclosure, the time and start timing of the anode scavenging can be adjusted according to the cathode scavenging status.

The gas used for the scavenging (drainage) may be an oxidant gas, a fuel gas, a nitrogen gas, or the like.

The gas used for the cathode scavenging may be an oxidant gas, a nitrogen gas, or the like.

The gas used for the anode scavenging may be a fuel gas, a nitrogen gas, or the like.

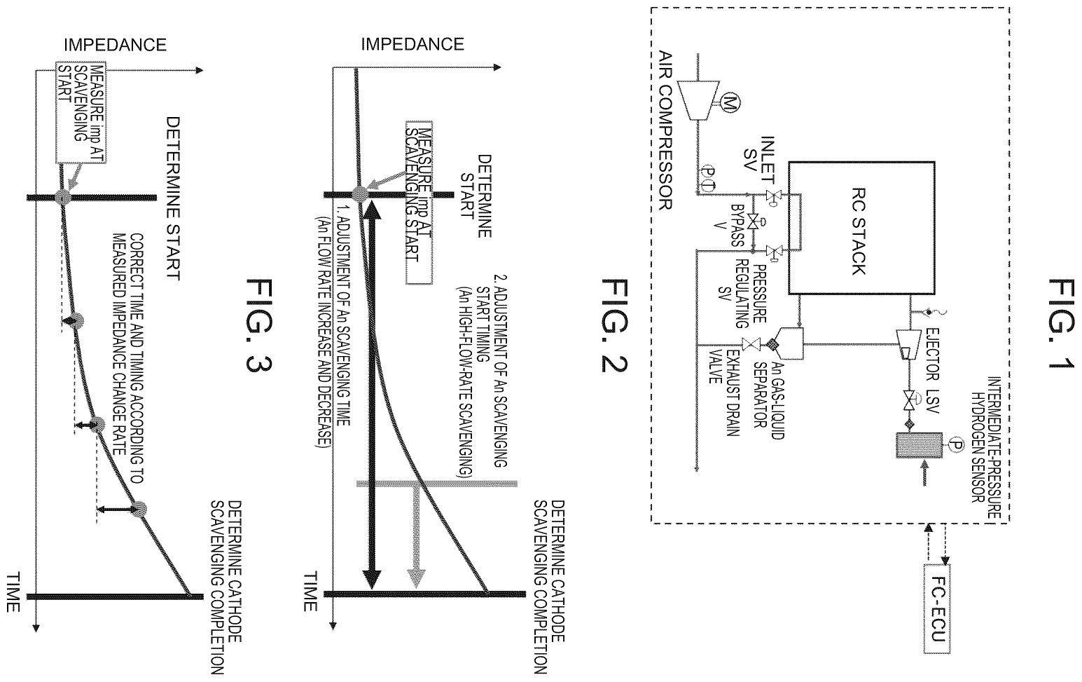

FIG. 1 is a schematic configuration diagram illustrating an example of a fuel cell system of the present disclosure. The fuel cell system illustrated in FIG. 1 includes an FC stack, an oxidant gas system, a fuel gas system, and a controller (FC-ECU).

The oxidant gas system includes an air compressor (ACP) driven by a motor M, a pressure sensor P, a temperature sensor T, and an oxidant gas inlet-sealing valve on an oxidant gas supply passage, and includes a pressure control valve on an oxidant off-gas discharge passage. Further, a bypass valve may be provided on a bypass passage.

The fuel gas system includes an ejector, a fuel gas inlet-sealing valve (LSV or injector (INJ)), and an intermediate-pressure sensor (intermediate-pressure hydrogen sensor) on a fuel gas supply passage, and includes an anode gas-liquid separator, an exhaust drain valve, and a circulation passage on a fuel off-gas discharge passage.

In FIG. 1, a cooling system is omitted for convenience.

The fuel cell system of the present disclosure includes a fuel cell, a water content estimation unit, and an anode scavenging setting unit.

The fuel cell system of the present disclosure may include an oxidant gas system, a fuel gas system, a cooling system, and a controller.

The fuel cell system of the present disclosure may be used by being mounted on a moving object such as a vehicle.

The fuel cell system of the present disclosure may be used by being mounted on a generator that supplies electric power to the outside.

The vehicle may be a fuel cell vehicle or the like. Examples of moving objects other than the vehicle include a train, a ship, and an aircraft.

The fuel cell system of the present disclosure may be used by being mounted on a moving object such as a vehicle that can also run on the power of a secondary battery.

The moving object may include the fuel cell system of the present disclosure. The moving object may include a drive unit such as a motor, an inverter, or a hybrid control system.

The hybrid control system may be capable of running the moving object using both the output of the fuel cell and the electric power of the secondary battery.

The fuel cell may be a fuel cell with only one single cell, or may be a fuel cell stack (sometimes referred to as an FC stack, a stack, etc.) that is a stack of a plurality of single cells. In the present disclosure, both the single cell and the fuel cell stack may be referred to as a fuel cell.

The number of stacked single cells is not particularly limited, and may be from two to several hundred, for example.

The single cell of the fuel cell usually includes a membrane electrode-gas diffusion layer assembly.

The membrane electrode-gas diffusion layer assembly includes an anode-side gas diffusion layer, an anode catalyst layer, an electrolyte membrane, a cathode catalyst layer, and a cathode-side gas diffusion layer in this order.

A cathode (oxidant electrode) includes the cathode catalyst layer and the cathode-side gas diffusion layer.

An anode (fuel electrode) includes the anode catalyst layer and the anode-side gas diffusion layer.

The cathode catalyst layer and the anode catalyst layer are collectively referred to as a catalyst layer.

The catalyst layer may include, for example, a catalyst metal that promotes an electrochemical reaction, an electrolyte with proton conductivity, a carrier with electron conductivity, and the like.

As the catalyst metal, for example, platinum (Pt), an alloy consisting of Pt and another metal (e.g., a Pt alloy mixed with cobalt, nickel, etc.), and the like can be used.

The electrolyte may be a fluorine-based resin or the like. As the fluorine-based resin, for example, a Nafion solution or the like may be used.

The catalyst metal described above is supported on a carrier, and in each catalyst layer, the carrier supporting the catalyst metal (catalyst-supporting carrier) may be mixed with an electrolyte.

Examples of the carrier for supporting the catalyst metal include commercially available carbon materials such as carbon.

The cathode-side gas diffusion layer and the anode-side gas diffusion layer are collectively referred to as a gas diffusion layer.

The gas diffusion layer may be a conductive member or the like with gas permeability.

Examples of the conductive member include carbon porous materials such as carbon cloth and carbon paper, and metal porous materials such as metal mesh and foamed metal.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. As the electrolyte membrane, for example, a Nafion membrane (manufactured by DuPont de Nemours, Inc.) or the like may be used.

If necessary, the single cell may include two separators that sandwich both sides of the membrane electrode gas diffusion layer assembly. One of the two separators is an anode-side separator and the other is a cathode-side separator. In the present disclosure, the anode-side separator and the cathode-side separator are collectively referred to as a separator.

The separator may include holes that constitute a manifold, such as a supply hole and a discharge hole, for allowing fluids like a reaction gas and a cooling medium to flow in the stacking direction of the single cells.

As the cooling medium, for example, coolant such as a mixed solution of ethylene glycol and water can be used to prevent freezing at a low temperature. As the cooling medium, cooling air can also be used.

Examples of the supply hole include a fuel gas supply hole, an oxidant gas supply hole, and a cooling medium supply hole.

Examples of the discharge hole include a fuel gas discharge hole, an oxidant gas discharge hole, and a cooling medium discharge hole.

The separator may include a reaction gas passage on the surface in contact with the gas diffusion layer. The separator may also include a cooling medium passage for maintaining the temperature of the fuel cell constant on the surface opposite to the surface in contact with the gas diffusion layer.

The separator may be a gas-impermeable conductive member or the like. The conductive member may be, for example, dense carbon obtained by compressing carbon to make it gas impermeable, or a press-formed metal (e.g., iron, aluminum, stainless steel, etc.) sheet. Further, the separator may have a current collection function.

The fuel cell stack may include a manifold such as an inlet manifold communicating with each supply hole and an outlet manifold communicating with each discharge hole.

Examples of the inlet manifold include an anode inlet manifold, a cathode inlet manifold, and a cooling medium inlet manifold.

Examples of the outlet manifold include an anode outlet manifold, a cathode outlet manifold, and a cooling medium outlet manifold.

In the present disclosure, the fuel gas and the oxidant gas are collectively referred to as a reaction gas. The reaction gas supplied to the anode is the fuel gas, and the reaction gas supplied to the cathode is the oxidant gas. The fuel gas is a gas mainly containing hydrogen, and may be pure hydrogen. The oxidant gas is a gas containing oxygen, and may be oxygen, air, dry air, or the like.

The oxidant gas system supplies the oxidant gas to the fuel cell.

The oxidant gas system may include an oxidant gas supply portion (air compressor), an oxidant gas supply passage, an oxidant off-gas discharge passage, a bypass passage, and the like.

The air compressor includes a bearing, a rotor, and a housing. The air compressor is electrically connected to the controller. In the air compressor, the number of revolutions of the rotor is controlled according to a control signal from the controller. The air compressor may be disposed in the oxidant gas supply passage.

The oxidant gas supply passage connects the outside of the fuel cell system to the cathode inlet of the fuel cell. The oxidant gas supply passage enables the supply of the oxidant gas from the air compressor to the cathode of the fuel cell. The cathode inlet may be the oxidant gas supply hole, the cathode inlet manifold, or the like. In the oxidant gas supply passage, an oxidant gas inlet-sealing valve may be disposed downstream of the air compressor.

The oxidant gas inlet-sealing valve is electrically connected to the controller, and by the controller opening the oxidant gas inlet-sealing valve, the oxidant gas is supplied to the cathode of the fuel cell.

The flow rate of the oxidant gas supplied to the cathode may be adjusted by adjusting the opening degree of the oxidant gas inlet-sealing valve.

In the oxidant gas supply passage, a pressure sensor, a temperature sensor, a flow rate sensor, and the like may be disposed downstream of the air compressor. The pressure sensor measures the pressure value of the cathode. The temperature sensor measures the temperature of the cathode. The flow rate sensor measures the flow rate of the oxidant gas.

The pressure sensor is electrically connected to the controller. The controller detects the pressure value of the cathode acquired by the pressure sensor.

The temperature sensor is electrically connected to the controller. The controller detects the temperature of the cathode acquired by the temperature sensor.

The flow rate sensor is electrically connected to the controller. The controller detects the flow rate of the oxidant gas acquired by the flow rate sensor.

The oxidant off-gas discharge passage connects the cathode outlet of the fuel cell to the outside of the fuel cell system. The oxidant off-gas discharge passage enables the discharge of an oxidant off-gas, which is an oxidant gas discharged from the cathode of the fuel cell, to the outside of the fuel cell system. The cathode outlet may be the oxidant gas discharge hole, the cathode outlet manifold, or the like. A pressure control valve may be disposed in the oxidant off-gas discharge passage. The pressure control valve is electrically connected to the controller, and by the controller opening the pressure control valve, the oxidant off-gas, which is the reacted oxidant gas, is discharged from the oxidant off-gas discharge passage to the outside of the fuel cell system. The pressure of the oxidant gas supplied to the cathode (cathode pressure) may be adjusted by adjusting the opening degree of the pressure control valve. Note that the component of the oxidant off-gas may be the same as the component of the oxidant gas, may be oxygen, air, dry air, or the like, or may contain water vapor or the like.

The bypass passage connects the oxidant gas supply passage and the oxidant off-gas discharge passage and bypasses the fuel cell. The bypass passage branches from the oxidant gas supply passage at a branch downstream of the air compressor in the oxidant gas supply passage, bypasses the fuel cell, and joins with the oxidant off-gas discharge passage at a junction downstream of the pressure control valve in the oxidant off-gas discharge passage.

A bypass valve may be disposed in the bypass passage. The bypass valve may be a valve with its opening degree adjustable, or may be a three-way valve for oxidant gas. In the case of the three-way valve for oxidant gas, the three-way valve may be disposed at a branch which is the most upstream of the bypass passage, and serves also as the oxidant gas inlet-sealing valve.

The bypass valve is electrically connected to the controller, and when the controller opens the bypass valve, at least a part of the oxidant gas can bypass the fuel cell to be supplied to the oxidant off-gas discharge passage. When the bypass valve is the three-way valve for oxidant gas, in a case where the supply of the oxidant gas to the fuel cell is not required or in other cases, the controller closes the valve on the downstream side of the oxidant gas supply passage of the bypass valve and opens the valve on the bypass passage side so that the flow of the oxidant gas shifts from the oxidant gas supply passage to the bypass passage, whereby the entire amount of the oxidant gas can be supplied to the oxidant off-gas discharge passage.

The oxidant gas system may include a cooler (intercooler) downstream of the air compressor in the oxidant gas supply passage. The cooler may be disposed in the oxidant gas supply passage downstream of the air compressor and upstream of the branch point from the bypass passage.

The cooler may exhibit a cooling function by circulating the cooling medium of the cooling system inside and outside the cooler.

The oxidant gas system may include a humidifier downstream of the air compressor in the oxidant gas supply passage. The humidifier may be disposed in the oxidant gas supply passage downstream of the air compressor and downstream of the branch point from the bypass passage.

The humidifier may be disposed across the oxidant gas supply passage and the oxidant off-gas discharge passage.

The fuel gas system supplies the fuel gas to the fuel cell.

The fuel gas system may include a fuel gas supply portion, a fuel gas supply passage, a fuel off-gas discharge passage, a circulation passage, an ejector, an intermediate-pressure sensor, and the like.

Examples of the fuel gas supply portion includes a fuel tank, specifically a liquid hydrogen tank, a compressed hydrogen tank, and the like.

The fuel gas supply passage connects the fuel gas supply portion and the anode inlet of the fuel cell. The fuel gas supply passage enables the supply of the fuel gas containing hydrogen to the anode of the fuel cell. The anode inlet may be the fuel gas supply hole, the anode inlet manifold, or the like.

The fuel off-gas discharge passage connects the anode outlet of the fuel cell to the outside of the fuel cell system. The anode outlet may be the fuel gas discharge hole, the anode outlet manifold, or the like.

The fuel off-gas may contain the fuel gas that has passed through the anode while remaining unreacted, moisture from product water that has been generated in the cathode and reached the anode, and the like. The fuel off-gas may contain a corrosive substance generated in the catalyst layer, the electrolyte membrane, and the like, an oxidant gas that may be supplied to the anode during scavenging, and the like.

The circulation passage branches from the fuel off-gas discharge passage at the branch of the fuel off-gas discharge passage, joins with the fuel gas supply passage at the junction of the fuel gas supply passage, and circulates the fuel off-gas as a circulation gas in the fuel gas system.

The ejector may be disposed at the junction of the fuel gas supply passage.

A fuel gas inlet-sealing valve may be located upstream of the ejector.

The fuel gas inlet-sealing valve is electrically connected to the controller, and by the controller opening the fuel gas inlet-sealing valve, the fuel gas is supplied to the anode of the fuel cell. The flow rate of the fuel gas supplied to the anode may be adjusted by adjusting the opening degree of the fuel gas inlet-sealing valve. The fuel gas inlet-sealing valve may be a linear solenoid valve, an injector, or the like.

The intermediate-pressure sensor may be disposed in the fuel gas supply passage upstream of the fuel gas inlet-sealing valve.

The intermediate-pressure sensor measures the pressure value of the anode.

The intermediate-pressure sensor is electrically connected to the controller. The controller detects the pressure value of the anode obtained by the intermediate-pressure sensor.

The anode gas-liquid separator and the exhaust drain valve may be disposed at the branch of the fuel off-gas discharge passage. The exhaust drain valve is electrically connected to the controller, and the controller controls the opening and closing of the exhaust drain valve.

The fuel cell system may include a cooling system.

The cooling system adjusts the temperature of the fuel cell.

The cooling system may include a cooling medium passage.

The cooling medium passage enables the cooling medium to circulate inside and outside the fuel cell. The cooling medium passage communicates with the cooling medium supply hole and the cooling medium discharge hole provided in the fuel cell, and enables the cooling medium to circulate inside and outside the fuel cell.

The cooling medium supply portion may be provided in the cooling medium passage. The cooling medium supply portion is electrically connected to the controller. The cooling medium supply portion is driven according to a control signal from the controller. The controller controls the flow rate of the cooling medium supplied from the cooling medium supply portion to the fuel cell. Thereby, the temperature of the fuel cell is controlled. Examples of the cooling medium supply portion includes a coolant pump.

The cooling medium passage may be provided with a radiator that radiates the heat of the cooling medium.

A reserve tank for storing the cooling medium may be provided in the cooling medium passage.

The fuel cell system may include a current sensor.

The current sensor measures the current of the fuel cell.

The current sensor is electrically connected to the controller. The controller detects the current of the fuel cell acquired by the current sensor.

The fuel cell system may include a battery.

The battery (secondary battery) may be any rechargeable battery, and examples thereof include conventionally known secondary batteries such as a nickel-metal hydride secondary battery and a lithium-ion secondary battery. The secondary battery may include a power storage element such as an electric double-layer capacitor. The secondary battery may have a configuration in which a plurality of secondary batteries is connected in series. The secondary battery supplies electric power to the air compressor or the like. The secondary battery may be rechargeable from a power source external to the vehicle, such as a household power source. The secondary battery may be charged by the output of the fuel cell. The controller may control the charging and discharging of the secondary battery.

The controller physically includes, for example, an arithmetic processing unit such as a central processing unit (CPU), a storage device such as a read-only memory (ROM), which stores a control program, control data, and the like to be processed by the CPU, and a random-access memory (RAM) mainly used as various work areas for control processing, and an input/output interface. The controller may be a control device such as a power control unit (PCU) or an electronic control unit (ECU).

The controller may be electrically connected to an ignition switch that may be mounted on the vehicle. The controller may be operable by an external power source even when the ignition switch is off.

The water content estimation unit (water accumulation amount estimation logic) estimates the water content of the cathode of the fuel cell before the cathode scavenging is started. The water content estimation unit may be included in the controller.

The water content estimation unit may include an impedance measurement unit. The water content estimation unit may estimate the water content of the cathode of the fuel cell with reference to the impedance information of the cathode measured by the impedance measurement unit. The water content estimation unit may store in advance a data group indicating the relationship between the impedance of the cathode and the water content of the cathode, and estimate the water content of the cathode of the fuel cell with reference to the data group.

The water content estimation unit may estimate the water content of the cathode during the cathode scavenging and calculate the water content change rate.

The anode scavenging setting unit (drainage process command logic) sets the time and start timing of the anode scavenging in the fuel cell based on the water content. The anode scavenging setting unit may be included in the controller.

The anode scavenging setting unit may include time counting means for the drainage process and the opening of the exhaust drain valve. The anode scavenging setting unit may make the frequency of the drainage process and the opening of the exhaust drain valve variable, using the time counting means for the drainage process and the opening of the exhaust drain valve.

The anode scavenging setting unit may change the time and start timing of the anode scavenging based on the water content change rate.

### First Embodiment

FIG. 2 is a graph illustrating an example of the relationship between the scavenging time and the impedance of the cathode of the fuel cell.

In a fuel cell system according to a first embodiment of the present disclosure, a water content estimation unit is provided with an impedance measurement unit, and the water content of the cathode of the fuel cell is estimated with reference to the impedance information of the cathode in order to control the scavenging time to be optimal for fuel efficiency and drainage performance for the anode drainage process in the fuel cell. Based on the estimated water content, the anode scavenging setting unit calculates and controls the optimal anode drainage time (which depends on the valve opening speed of the fuel gas inlet-sealing valve of the fuel gas system) and drainage start time for fuel consumption.

The adjustment of the anode scavenging time (increase and decrease in An flow rate) in the fuel cell may be set by measuring the impedance of the cathode at the start of the cathode scavenging (before the start of the scavenging) as illustrated in FIG. 2, and back-calculating the completion time of the cathode scavenging from the estimated value of the water content at the start of the cathode scavenging to calculate a pressure rate. With the fuel consumption having a concave characteristic over time, the anode scavenging time may be adjusted from the start of the cathode scavenging.

The adjustment of the anode scavenging start timing (An high-flow-rate scavenging) in the fuel cell may be set by measuring the impedance of the cathode at the start of the scavenging (before the start of the scavenging) as illustrated in FIG. 2, and calculating the optimal anode scavenging start timing for fuel consumption, from the estimated value of the water content at the start of the cathode scavenging. Increasing the flow rate reduces the boost time per cycle, but increases the number of boost cycles, thus leading to a slight deterioration in fuel consumption. There is a method to widen the pressure deviation, but the upper limit pressure is restricted, and cross leakage also increases, thus leading to a deterioration in fuel consumption. Accordingly, when the anode scavenging start timing is sufficiently shorter than the cathode scavenging time, the end timing of the cathode scavenging may be adjusted to coincide with the end timing of the anode scavenging in order to remove product water.

### Second Embodiment

FIG. 3 is a graph illustrating another example of the relationship between the scavenging time and the impedance of the cathode of the fuel cell.

In a fuel cell system according to a second embodiment of the present disclosure, when the increase rate of the impedance remarkably changes due to the humidified state of the fuel cells or the humidity of the blown air, in addition to the first embodiment, as illustrated in FIG. 3, the water content estimation unit may measure the impedance at the start of the cathode scavenging and during the scavenging, and estimate the water content change rate of the cathode from the impedance change rate, and the anode scavenging setting unit may correct the time and start timing of the anode scavenging based on the water content change rate of the cathode.

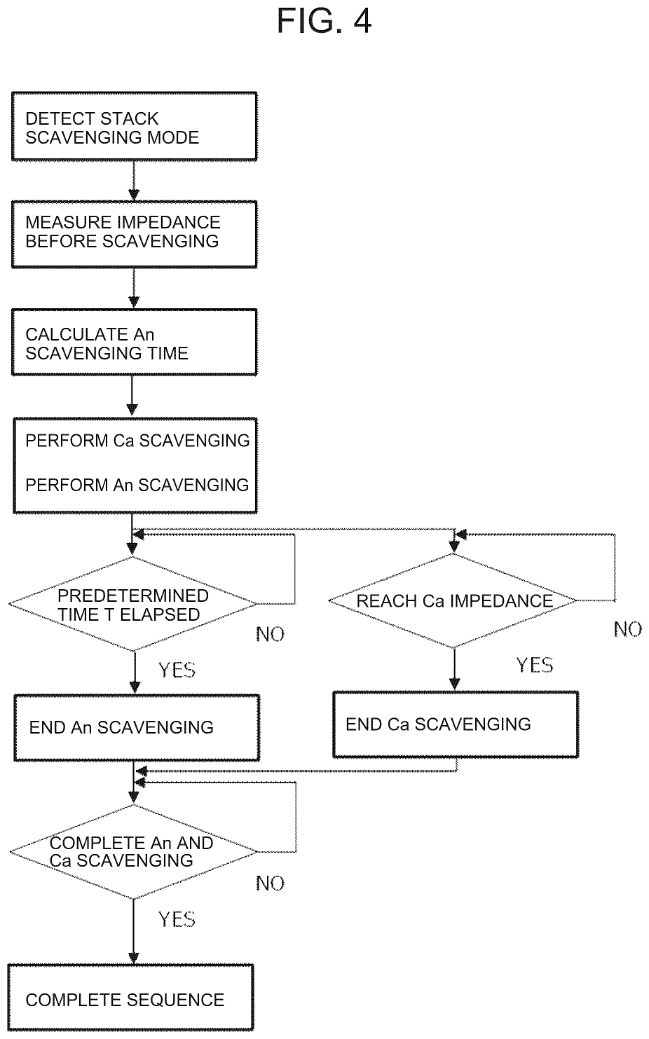

FIG. 4 is a flowchart illustrating an example of control performed by the fuel cell system of the present disclosure.

As illustrated in FIG. 4, when the water content estimation unit detects a scavenging mode of the fuel cell stack (stack), the water content estimation unit measures the impedance of the cathode before the controller starts scavenging. Based on the measured impedance, the anode scavenging setting unit calculates scavenging time T (predetermined time T) of the anode.

Then, the controller performs the anode scavenging and cathode scavenging. When the predetermined time T has elapsed, the controller ends the anode scavenging, and when a predetermined impedance is reached, the controller ends the cathode scavenging, thereby completing the sequence.

In FIG. 4, the cathode scavenging and the anode scavenging are performed at the same timing. The end time of the cathode scavenging is predicted, and the scavenging time T of the anode is set so that the anode scavenging ends at the same timing as the cathode scavenging. The anode scavenging is performed while the flow rate of the scavenging is controlled. This enables efficient scavenging to be performed.

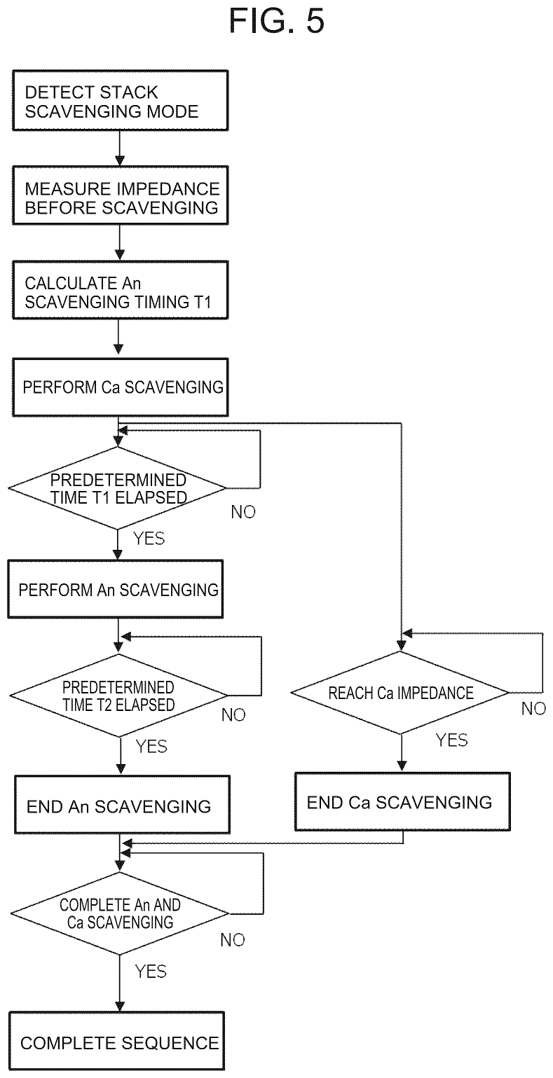

FIG. 5 is a flowchart illustrating another example of the control performed by the fuel cell system of the present disclosure.

As illustrated in FIG. 5, when the water content estimation unit detects the scavenging mode of the fuel cell stack, the water content estimation unit measures the impedance of the cathode before the controller starts scavenging. Based on the measured impedance, the anode scavenging setting unit calculates scavenging timing T1 (predetermined time T1) and predetermined time T2 for scheduled scavenging of the anode. Then, the controller performs the cathode scavenging. When the predetermined time T1 has elapsed since the start of the cathode scavenging, the controller performs the anode scavenging, and when the predetermined time T2 has elapsed, the controller ends the anode scavenging. When a predetermined impedance is reached, the controller ends the cathode scavenging, thereby completing the sequence.

In FIG. 5, the end time of the cathode scavenging is predicted, and the scavenging timing T1 (predetermined time T1) of the anode and the predetermined time T2 of the anode scavenging are set so that the anode scavenging is completed at the same timing as the cathode scavenging. When the predetermined time T1 has elapsed since the start of the cathode scavenging, the anode scavenging is performed at a high flow rate in the predetermined time T2. This enables efficient scavenging to be performed.

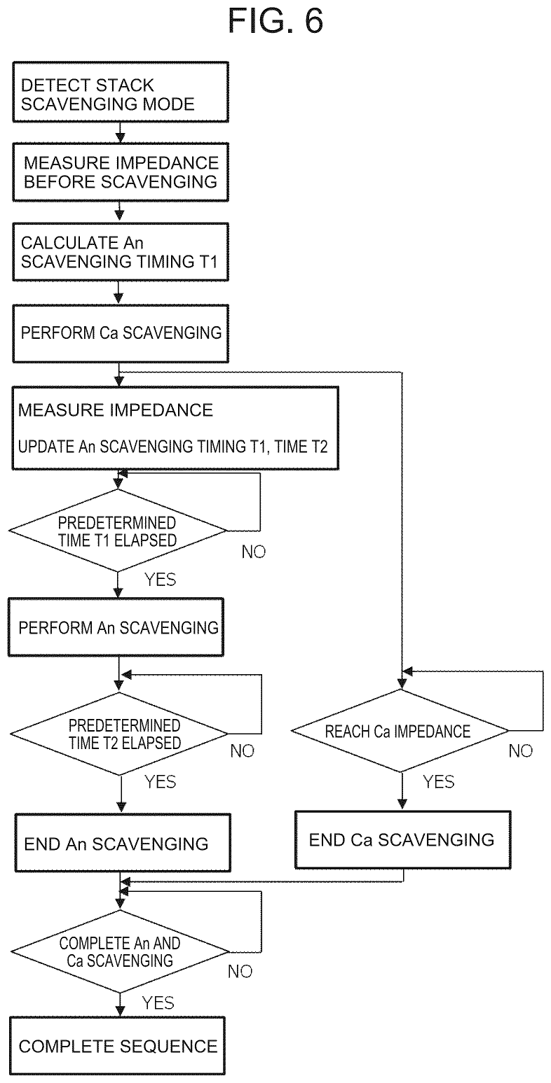

FIG. 6 is a flowchart illustrating another example of the control performed by the fuel cell system of the present disclosure.

As illustrated in FIG. 6, when the water content estimation unit detects the scavenging mode of the fuel cell stack, the water content estimation unit measures the impedance of the cathode before the controller starts scavenging. Based on the measured impedance, the anode scavenging setting unit calculates scavenging timing T1 (predetermined time T1) of the anode and predetermined time T2 for scheduled scavenging of the anode.

Then, the controller performs cathode scavenging, and after the start of the cathode scavenging, the water content estimation unit measures the impedance of the cathode again. Based on the measured impedance, the anode scavenging setting unit corrects and updates the scavenging timing T1 (predetermined time T1) of the anode and the predetermined time T2 for scheduled scavenging of the anode.

When the updated predetermined time T1 has elapsed, the controller performs the anode scavenging, and when the predetermined time T2 has elapsed, the controller ends the anode scavenging. When a predetermined impedance is reached, the controller ends the cathode scavenging, thereby completing the sequence.

In FIG. 6, after the start of the cathode scavenging, the impedance of the cathode is measured again. The scavenging timing T1 (predetermined time T1) of the anode and the predetermined time T2 for scheduled scavenging of the anode are corrected and updated based on the measured impedance. When the updated predetermined time T1 has elapsed, the anode scavenging is performed at a high flow rate in the predetermined time T2. By measuring the impedance during the cathode scavenging and correcting the scavenging timing T1 (predetermined time T1) and the predetermined time T2 for scheduled scavenging, the scavenging can be performed with high fuel efficiency.

What is claimed is:

1. A fuel cell system comprising:
a fuel cell;
a water content estimation unit; and
an anode scavenging setting unit, wherein
the water content estimation unit estimates a water content of a cathode of the fuel cell before scavenging of the cathode is started, and
the anode scavenging setting unit sets time and start timing of scavenging of an anode of the fuel cell based on the water content.

2. The fuel cell system according to claim 1, wherein
the water content estimation unit estimates the water content of the cathode during the scavenging of the cathode and calculates a water content change rate, and
the anode scavenging setting unit changes the time and the start timing of the scavenging of the anode based on the water content change rate.
